(19) United States
(12) Patent Application Publication
(10) Pub. No.: US 2022/0063801 A1
(43) Pub. Date: Mar. 3, 2022

(54) Human-Powered Flying Apparatus

(71) Applicant: Elý N. Nalvarte-Loya, Aurora, CO (US)

(72) Inventor: Elý N. Nalvarte-Loya, Aurora, CO (US)

(21) Appl. No.: 17/028,856

(22) Filed: Sep. 22, 2020

Related U.S. Application Data
(60) Provisional application No. 63/073,731, filed on Sep. 2, 2020.

(51) Int. Cl. B64C 33/02

(52) U.S. Cl. CPC B64C 33/02

(57) ABSTRACT

Embodiments described herein are related to a flying apparatus. The flying apparatus may include a frame support structure having an inter-wing hinge operatively coupled to a first and second wing, a center pole that bisects the inter-wing hinge, and a pair of cross rods attached to the center pole below the first and second wings. The flying apparatus may further include first and second folding hinges attached to first and second cross rods and a first movement transmission rod operatively coupled between a first end of the first folding hinge and an outer portion of the first wing, and a second movement transmission rod operatively coupled between a first end of the second folding hinge and an outer portion of the second wing, wherein actuation of the first folding hinge and the second folding hinge is to move the first and second wings one of up or down.

### REFERENCE TO RELATED APPLICATION

The present application claims the benefit of priority to U.S. Provisional Application No. 63/073,731 filed Sep. 2, 2020, the disclosure of which is incorporated herein by reference in its entirety for all purposes.

### BACKGROUND

A human-powered aircraft relies on a human (i.e. a pilot) to generate enough power for the aircraft to take and maintain flight. Human-powered flight presents many challenges one of which is overcoming the power-to-weight ratio. A power-to-weight ratio is a measurement of actual performance of a power source (e.g., input from the pilot) to overcome the overall weight (e.g., the combined weight of the pilot and aircraft.) Human-powered aircraft may include mechanical devices such as human powered wings, propellers, or the like to generate enough lift to overcome the overall weight.

### BRIEF DESCRIPTION OF THE DRAWINGS

The present disclosure is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one.

FIG. 1 illustrates a perspective view of a flying apparatus, according to certain embodiments.

FIG. 2 illustrates a bottom view of a flying apparatus, according to certain embodiments.

FIG. 3A illustrates a front view of an expanded flying apparatus in which the wings are in a raised position, according to certain embodiments.

FIG. 3B illustrates a front view of a compressed flying apparatus in which the wings are in a lowered position, according to certain embodiments.

FIG. 4 illustrates top view of a flying apparatus, according to certain embodiments.

FIG. 5 illustrates a wing configuration of a flying apparatus, according to certain embodiments.

### DETAILED DESCRIPTION OF EMBODIMENTS

Embodiments described herein are related to a human powered flying apparatus. Human powered flying apparatuses may be used recreationally, competitively, for transportation, or the like. A flying apparatus may have a pair of wings to generate lift while in motion. Handles may be a part of the flying apparatus for a pilot to hold onto while riding. A flying apparatus may include a seat or harness for a passenger to ride while in flight. A flying apparatus may include a device or system for generating lift by receiving power through physical exertion by the pilot.

Conventionally, a human-powered flying apparatus may include a mechanical-based apparatus that contains structures such as human powered wings, propellers, pedals, or the like to generate enough lift to overcome the combined weight of the apparatus and the pilot. However, use of these mechanical systems require constant physical exertion by the pilot of the flying apparatus to take or maintain flight. For example, a pilot may be required to pedal above a threshold speed to generate sufficient power to overcome the combined weight of the apparatus and the pilot. If the pedal speed is not maintained above the minimum threshold speed the apparatus will not generate enough lift to either take or maintain flight. Conventionally, human powered flying apparatuses may involve constant physical exertion by the pilot to take-off, maintain flight, and make directional changes to a flight path. Accordingly such conventional apparatuses are unsuited for long flights or flights in wind or weather that will quickly tire the pilot.

The devices and systems disclosed herein have advantages over conventional apparatuses. The devices and systems disclosed herein provide a human powered flying apparatus that enables a pilot to maintain and adjust a flight path without constant physical exertion by the pilot. In some embodiments, the flying apparatus may include a pair of wings that are rotated about an inter-wing hinge to control the flight path of the flying apparatus. The flying apparatus may include structures such as an angular lever, hand grips, and tension lines to allow a pilot to control the height and angle of the wings from a central inter-wing hinge. The flying apparatus may include a frame support structure that causes the flying apparatus to maintain a flight path without constant physical exertion by the pilot. The frame support structure may include one or more mechanical stops disposed above a set of wings to prevent the wings from rotating beyond a specified angle relative to a central inter-wing hinge. The frame support may include a safety bracket and tension cables that prevent the wings from moving into an orientation that causes undesired large directional changes to the flight path.

The flying apparatus may include a frame support structure having an inter-wing hinge operatively coupled to a first and second wing, a center pole that bisects the inter-wing hinge, and a pair of cross rods attached to the center pole below the first and second wings. The flying apparatus may further include first and second folding hinges attached to first and second cross rods and a first movement transmission rod operatively coupled between a first end of the first folding hinge and an outer portion of the first wing, and a second movement transmission rod operatively coupled between a first end of the second folding hinge and an outer portion of the second wing, wherein actuation of the first folding hinge and the second folding hinge is to move the first and second wings either up or down.

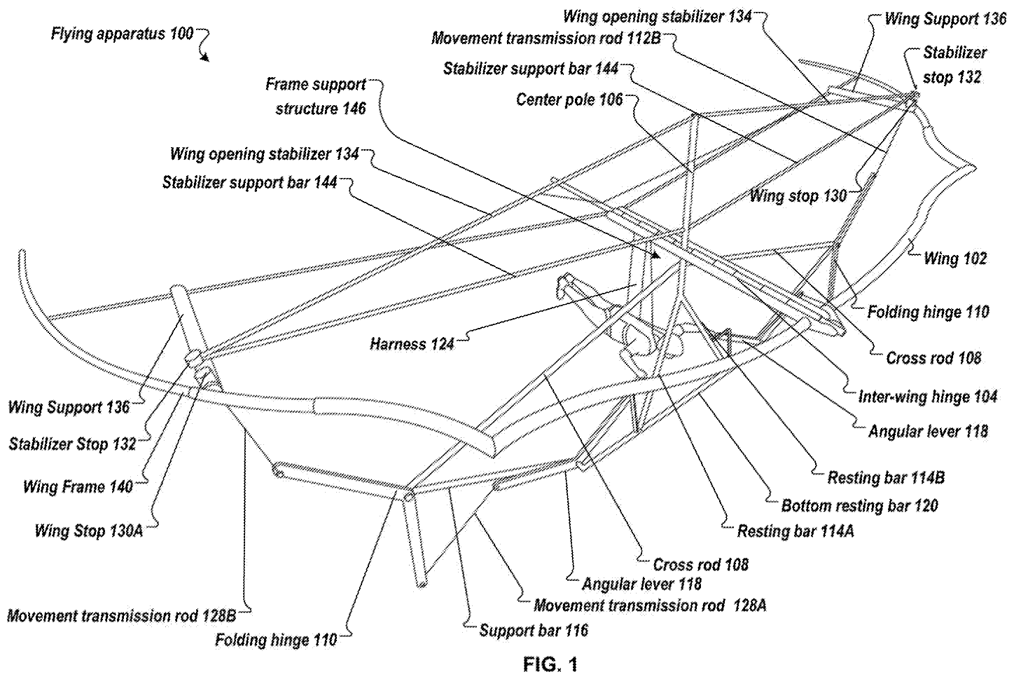

FIG. 1 illustrates a perspective view of a flying apparatus 100, according to certain embodiments. The flying apparatus 100 may include wings 102, and a frame support structure 146 including an inter-wing hinge 104 and a center pole 106. The inter-wing hinge 104 may be operatively coupled to the wings 102. The wings may rotate about the inter-wing hinge 104. In some embodiments, the wings 102 may rotate in coordination with each other such that a first wing (e.g., 102A) may rotate in a first azimuthal direction about the inter-wing hinge 104 and a second wing (e.g., 102B) may rotate in a second azimuthal direction about the inter-wing hinge 104 opposite the first azimuthal direction to generate a coordinated motion between the wings. For example, the wings 102 may oscillate back and forth around the inter-wing hinge 104 to generate a flapping motion. In some embodiments, the motion of one wing may be independent of the other wing. For example, a first wing (e.g., 102A) may be stationary while a second wing (e.g., 102B) rotates about the inter-wing hinge 104.

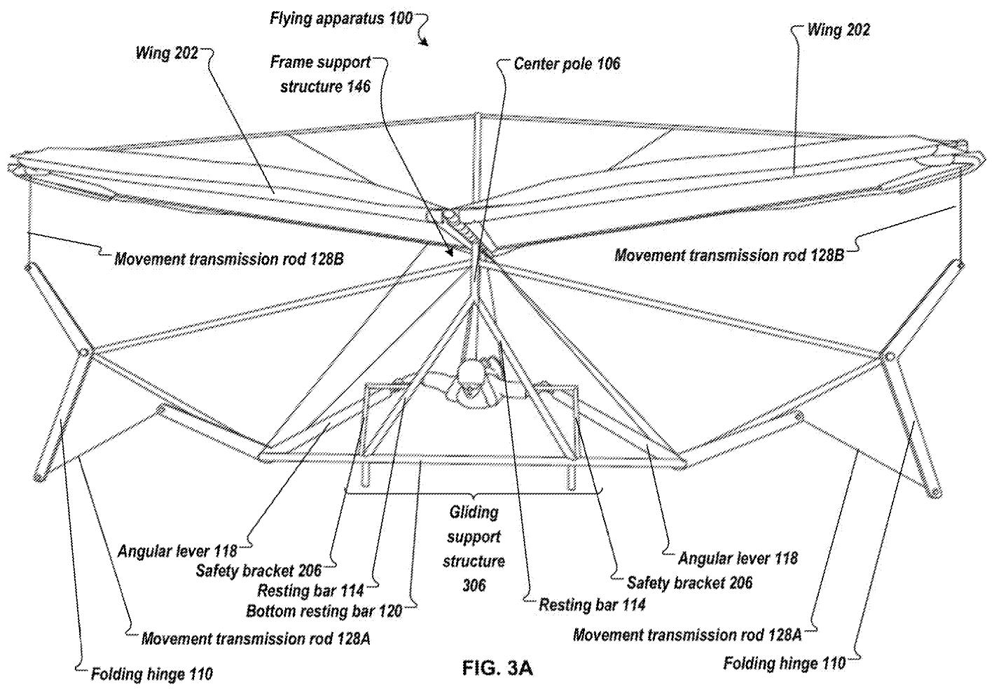

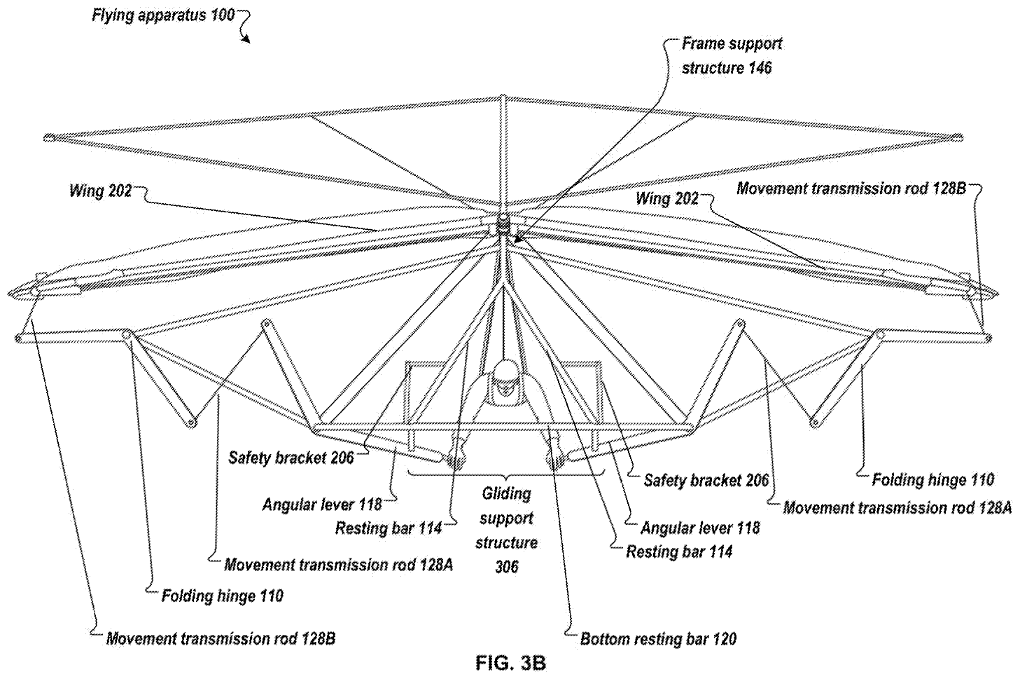

As shown in FIG. 1, the center pole 106 may bisect the inter-wing hinge 104. The center pole 106 may be round, circular, or of a shape or structure conducive to aerodynamics. The frame support structure 146 may further include a gliding support structure. The center pole 106 may be attached to the gliding support structure (e.g., see gliding support structure 306 of FIG. 3B). The gliding support structure (e.g., see gliding support structure 306 of FIG. 3B) may include one or more resting bars 114A, 114B, and a bottom resting bar 120. The one or more resting bars 114 may be attached or integrated into a bottom side of the center pole 106. The bottom resting bar 120 may be disposed below the one or more resting bars 114. The bottom resting bar may be attached to an end of a first resting bar 114A and a second resting bar 114B. The bottom resting bar 120 may be coupled between a pair of angular levers 118.

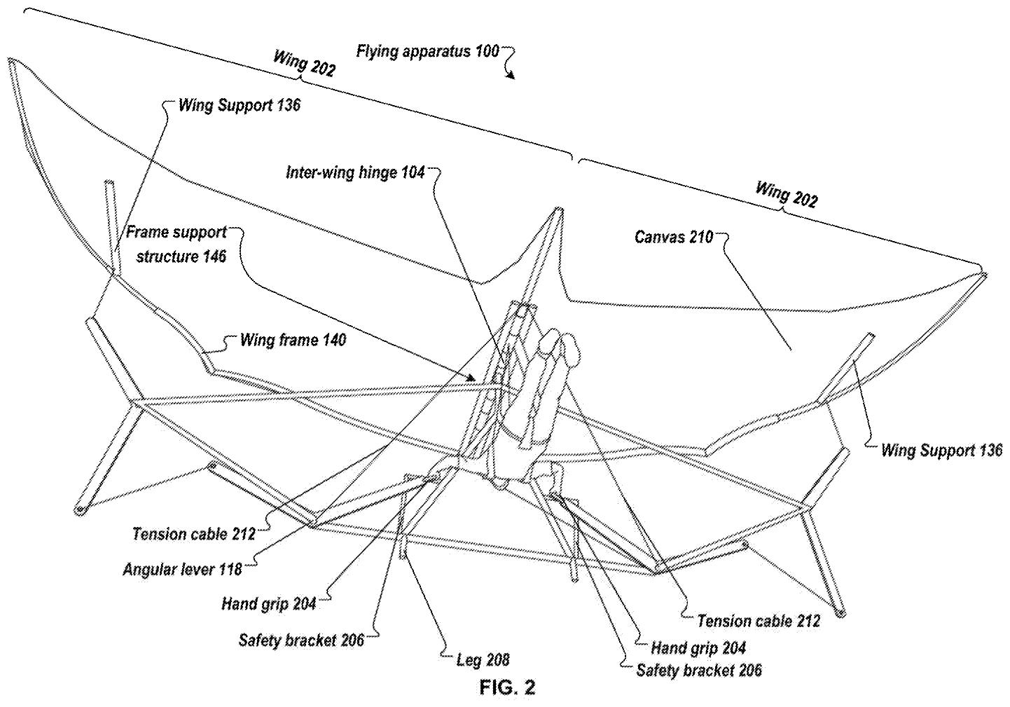

As shown in FIG. 1, angular levers 118 may include two straight segments that come together to form an angle. The angle may be formed at a central location of each of the angular levers 118. The angular levers may form a rotary hinge. The central location of each of the angular levers 118 may include an attachment device to couple with the bottom resting bar 120. The angular levers 118 may be selectively coupled or affixed to an end of the bottom resting bar 120. The angular levers 118 may be designed to rotate about a contact point between an end of the bottom resting bar 120 and the angle of each of the angular levers 118. One end of each of the angular levers may include a hand grip (e.g., see hand grips 204 of FIG. 2). One end of each of the angular levers 118 may be operatively coupled to a folding hinge 110 through a movement transmission rod 128.

As shown in FIG. 1, folding hinges 110 may include two straight segments that come together to form an angle. The angle may be formed at a central location of each of the folding hinges 110. The folding hinges 110 may form a rotary hinge. The central location of each of the folding hinges 110 may include an attachment device to couple the folding hinges with a cross rod 108 of the frame support structure 146. The folding hinges 110 may be designed to rotate about a contact point between an end of a cross rod 108 and the angle of each of the folding hinges 110. One end of each of the folding hinges 110 may be operatively coupled to an angular lever 118 through a movement transmission rod 128. One end of each of the folding hinges 110 may be operatively coupled to a wing 102 through a movement transmission rod 128.

As shown in FIG. 1, movement transmission rods 128 may be disposed between an angular lever 118 and a folding hinge 110. Movement transmissions rods 128 may be disposed between a folding hinge 110 and a wing 102. Movement transmission rods 112 may be made of a rigid material such that rod maintains a lateral shape and size when a force is being applied.

In some embodiments, the angular levers 118 are attached or physically coupled to the folding hinges 110 through a support bar 116. The angular levers 118 may include centers or apexes, where the angular levers 118 are designed to rotate about. Support bar 116 may be selectively coupled or affixed near a center or apex of an angular lever 118 and an apex of a folding hinge 110. An angular lever 118 may be operatively coupled to a folding hinge 110 through a movement transmission rod 128 such that when the angular lever 118 is pressed the folding hinge 110 rotates. For example, a pilot of the flying device may press an end of the angular lever 118. Responsive to the pilot pressing a first end of the angular lever 118, a second end of the angular lever 118 rotates about a center or apex of the angular lever 118. The opposite end of the angular lever 118 may be coupled to a movement transmission rod 128 that is also coupled to an end of a folding hinge 110. The second end of the angular lever may apply a force to the movement transmission rod 128 resulting in the movement transmission rod 128 moving laterally. The movement transmission rod 128 may apply a force to the folding hinge resulting in the folding hinge 110 rotating about a center or apex of the folding hinge 110.

In some embodiments, the rotation of a folding hinge 110 may control positioning of a wing about the inter-wing hinge 104 through the movement transmission rod 112. For example, a folding hinge may rotate, resulting in an end of the folding hinge coupled to the movement transmission rod 112 to rotate in an azimuthal direction about a center or apex of the folding hinge 110. Responsive to this rotation, the movement transmission rod 112 is laterally put in motion resulting in a wing 102 rotating into a new position about the inter-wing hinge 104. This motion may be repeated to generate a flapping motion by the wings 102 that may generate lift.

The frame structure support of the flying apparatus 100 may include support bars 116 and cross rods 108. The support bars 116 may be disposed between angular lever 118 and folding hinge 110. For example, a support bars 116 may be coupled to an angular lever 118 such that the angular lever 118 may rotate about an end of the support bar 116. In another example, a support bar 116 may be coupled to a folding hinge 110 such that the folding hinge 110 may rotate about an end of the support bar 116. The cross rods 108 may be disposed between the center pole 106 and a folding hinge 110. An end of the cross rods 108 may be affixed or integrated into the center pole 106. An end of the cross rods 108 may be coupled to an end of the support bars 116. The one or more cross rods 108 may be disposed below the wings 102. The one or more cross rods 108 may be attached to or be integrated into one or more folding hinges 110. The cross rods 108 may be operatively coupled to the folding hinges 110 such that the folding hinges 110 rotate about a point located on the end of the cross rod 108.

The wings 102 may include a canvas (e.g., see canvas 304 of FIGS. 3A and 3B) and a wing frame 140 that extends along a front side of the flying apparatus 100. The wing frame 140 may outline a wing shape of the canvas (e.g., canvas 304 of FIGS. 3A and 3B). For example, the wings 102 may be round, rectangular, or form bat-wing-shaped wings. A wing support 136 may be attached to the wing frame 140 and include one or more stops 130 of the wings. The stops 130 may include a contact surface that directly opposes a stop 132 of a wing opening stabilizer 134. The stops 130 of the wing support 126 and the stops 132 of the wing opening stabilizer 134 may come in contact to prevent the wings 102 from rotating beyond a threshold angle about the inter-wing hinge 104. The stops 130 and 132 may be made of a flexible material (e.g., rubber) such that the stops absorb an impact from contact between the wing supports 136 and the wing opening stabilizer 134. In some embodiments, tension lines are coupled between the wing opening stabilizers 134 and a rear portion of the inter-wing hinge 104.

As shown in FIG. 1, the center pole 106 attaches to the wing opening stabilizers 134. The stabilizer support bars 144 and wing opening stabilizers 134 may be disposed above the wings. The stabilizer support bars 144 and wing opening stabilizers 134 may be attached to or integrated into the center pole 106. The stabilizer support bars 144 and wing opening stabilizers 134 may extend up to or beyond the wing frames. The stabilizer support bars 144 and a distal end of the wing opening stabilizers 134 may come together at a point and form a mechanical stop 132. The stabilizer support bars 144 and a distal end of the wing opening stabilizers 134 may extend to a point above the wings such that when the wings rotates a mechanical stop 132 of a wing support 136 may contact a mechanical stop of the wing opening stabilizer 134 and stabilizer support bars 144. In some embodiments, the mechanical stop of the wing opening stabilizer 134 directly opens the mechanical stop 132 of the wing support 136. For example, the wing opening stabilizers 134 may be disposed directly above the stabilizer support bars 144.

The flying apparatus 100 may include a harness 124. The harness may include straps designed to hold a pilot in place while operating the flying apparatus 100. The harness may hold a pilot within reach of the resting bars 114 and/or the angular levers 118 so that the pilot can alternately grab hold of the resting bars 114 and the angular levels 118.

FIG. 2 illustrates a bottom view of a flying apparatus 100, according to certain embodiments. Some elements in FIG. 2 may have the same number as other figures, and these elements may be substantially similar to those elements having the same number in other figures. The flying apparatus may include tension cables 212, hand grips 204, and safety brackets 206. The tension cables may be coupled to an angular lever 118 and an inter-wing hinge 104. The hand grips 204 may be disposed on a first end of an angular lever 118. For example, the hand grips 204 may extend beyond the end of an angular lever 118 to be within reach of a pilot of the flying apparatus 100. The hand grips 204 may include a looped handle bar for a pilot to grasp and maintain control.

As shown in FIG. 2, safety brackets 206 may include a contacting element or engagement element on an end of the safety brackets 206 such that the safety may contact or engage the angular lever 118 and/or hand grips to maintain a position of the angular lever 188. Safety bracket 206 may be disposed above an angular lever 118 to prevent the angular lever 118 from rotating beyond a threshold angle. Preventing the rotation of the angular lever 118 may result in restricting the motion of the wing. For example, the wings (e.g., 202 of FIG. 2) may be stabilized and prevented from rotating about the inter-wing hinge 104 when the safety brackets 206 are engaged with the angular levers 118. This may result in consistent stability of the flying apparatus 100 without constant physical exertion by the pilot.

As shown in FIG. 2, the frame support structure 146 may include one or more legs 208 that extend below a bottom resting bar (e.g., see bottom resting bar 120 of FIG. 1). The one or more legs 208 may be configured to contact a ground surface. The one or more legs 208 may be configured to hold the flying apparatus 100 upright when not in use.

As shown in FIG. 2, the wings 202 may include a wing frame 140, a wing support 136, and a canvas 210. Wing frame 140 may include a series of rod forming a shape of the wing. Wing support 136 may include a rod or structure that may assist in the stability of the wings 202. Wing support 136 may be attached or integrated into a portion of the wing frame 140. Canvas 210 may be affixed or coupled to the wing frame 140. Canvas 210 may be made of a cloth or woven fabric.

FIG. 3A illustrates a front view of an expanded flying apparatus 100 in which the wings are in a raised position, according to certain embodiments. FIG. 3B illustrates a front view of a compressed flying apparatus in which the wings are in a lowered position, according to certain embodiments. Some elements in FIGS. 3A and 3B may have the same number as other figures, and these elements may be substantially similar to those elements having the same number in other figures.

As shown in FIGS. 3A-3B, the flying apparatus 100 may include a frame support structure 146 having a center pole 106. The frame support structure 146 may also include a gliding support structure 306. The gliding support structure 306 may be attached at an end of the center pole 106. The gliding support structure 306 may include a bottoms resting bar 120 that may be coupled between two angular levers 118. The gliding support structure 306 may be triangular with the bottom resting bar 120 forming a bottom side, and two resting bars 114 forming the other two sides. The gliding support structure 306 may include one or more safety brackets 206 attached too one or more sides of the gliding support structure.

The flying apparatus 100 may include structures designed to actuate one or more wings 202. In some embodiments, actuating one or more angular levers 118 actuates the one or more wings 202. For example, actuating one or more angular levers 118 actuates first movement transmissions rods 128A that, in turn, actuate one or more folding hinges 110. The folding hinges 110 further actuate second movement transmission rods 128B that, in turn, actuate the wings 102.

In one embodiment, when the pilot pulls the angular levers 118 back towards the rear of the flying apparatus 100, the folding hinges 110 actuate the second movement transmission rods 128B to lift the wings, as illustrated in FIG. 3A. Further, when the pilot pushes the angular levers 118 outwardly away from the pilot, the folding hinges 110 move the second movement transmission rods 128B to lower the wings, as illustrated in FIG. 3B.

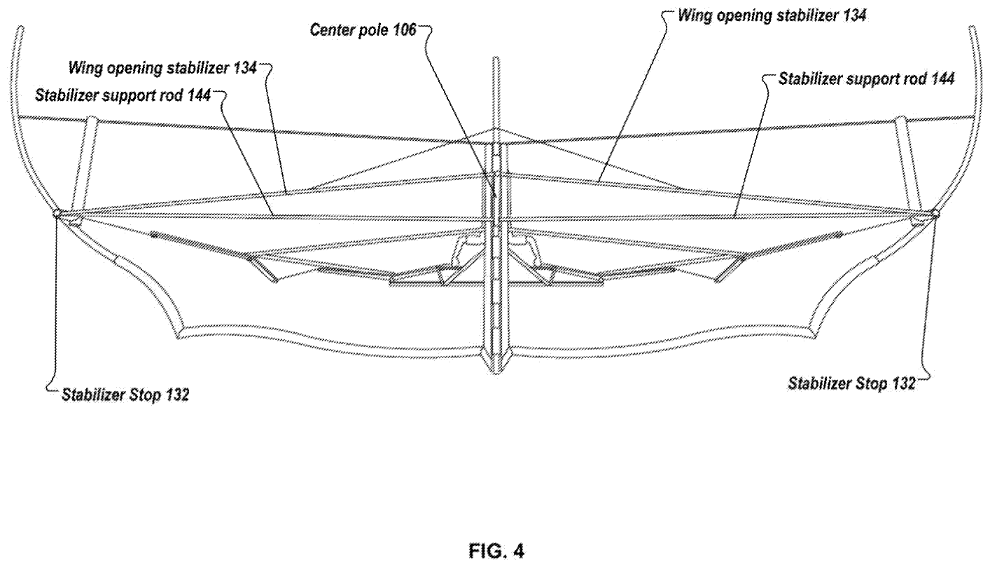

FIG. 4 illustrates a top view of a flying apparatus 100, according to certain embodiments. Some elements in FIG. 4 may have the same number as other figures, and these elements may be substantially similar to those elements having the same number in other figures. The flying apparatus may include support frame structure having a center pole, wing opening stabilizers 134, and stabilizer support rods 144. The wing opening stabilizers 134 and the one or more stabilizer support bars 144 may be coupled to the center pole 106. The ends of the wing opening stabilizer 134 and the stabilizer support bars 144 opposite the center pole 106 may come together at a point and include wing opening stabilizer stops 132. The wing opening stabilizer stops 132 may be designed to contact a portion of a wing (e.g., see wing 202 of FIG. 2) and prevent the wing from rotating beyond a threshold angle relative to an inter-wing hinge, e.g., inter-wing hinge 104.

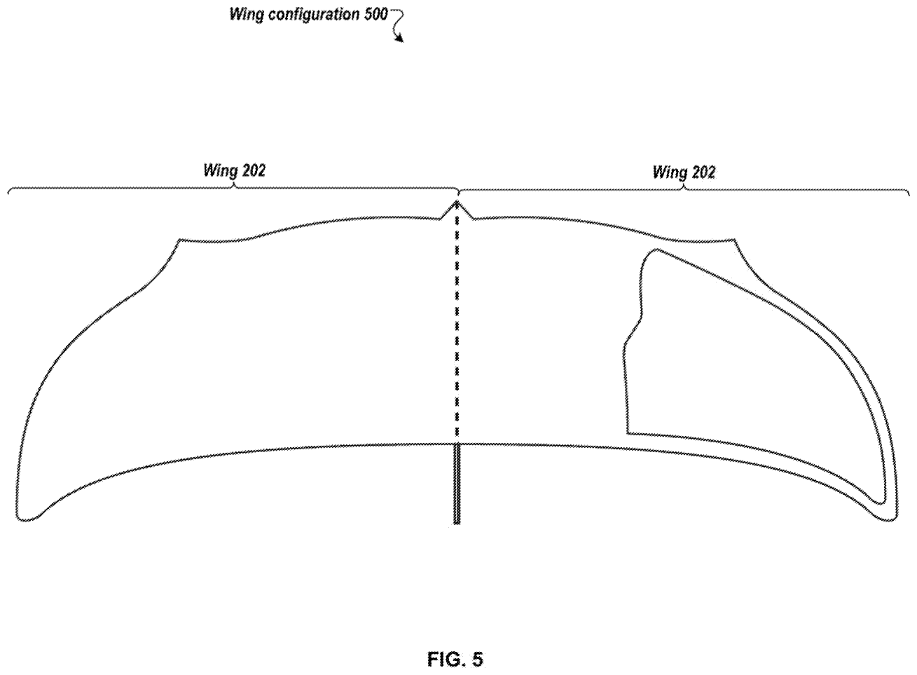

FIG. 5 illustrates a wing configuration 500 of a flying apparatus (e.g., flying apparatus of FIGS. 1-4), according to certain embodiments. Some elements in FIG. 5 may have the same number as other figures, and these elements may be substantially similar to those elements having the same number in other Figures herein. The wings 102 may be configured into a circular shape, a triangular shape, a bat-like, or another shape or structure conducive to aerodynamics. The wings 102 may include a canvas made of a cloth fiber, woven fiber, or a material conducive to generating lift while in flight.

The preceding description sets forth numerous specific details such as examples of specific system, components, devices and so forth in order to provide a good understanding of several embodiments of the present disclosure. It will be apparent to one skilled in the art, however, that at least some embodiment of the present disclosure may be practiced without these specific details. In other instances, well-known components or methods are not described in detail to avoid unnecessarily obscuring the present disclosure. Thus, the specific details set forth are merely exemplary. Particular implementations may vary from these exemplary details and still be contemplated to be within the scope of the present disclosure.

Reference throughout this specification to “some embodiments,” “one embodiment,” or “an embodiment” means that a particular feature, structure, or characteristic described in connection with the embodiment is included in at least one embodiment. Thus, the appearance of the phrase “in some embodiments,” “in one embodiment,” or “in an embodiment” in various places throughout this specification are not necessarily all referring to the same embodiment. Furthermore, a person having ordinary skill in the art will recognize that the elements, components, and devices found in an embodiment of the system may be combined with any element, component, or device of another embodiment and that the use of any specified element, component, or device is not isolated to the exemplary embodiment within where it is described. In addition, the term “or” is intended to mean an inclusive “or” rather than an exclusive “or.” When the term “about”, “approximately”, or “substantially” is used herein, this is intended to mean the nominal value or characteristic presented is precise within ±10%.

The terms “over,” “above” “under,” “between,” and “on” as used herein refer to a relative position of one material layer or component with respect to other layers or components. For example, one element, component, or device disposed above, over, or under another element, component, or device may be directly in contact with the other element, component, or device or may have one or more intervening elements, components, or devices. Moreover, one element, component, or device disposed between two elements, components, or devices may be directly in contact with the two elements, components, or devices or may have one or more intervening elements, components, or devices. Similarly, unless explicitly stated otherwise, one feature disposed between two features may be in direct contact with the adjacent features or may have one or more intervening features.

It is understood that the above description is intended to be illustrative, and not restrictive. Many other embodiments will be apparent to those of skill in the art upon reading and understanding the above description. The scope of the disclosure should, therefore, be determined with reference to the appended claims, along with the full scope of equivalents to which such claims are entitled.

What is claimed is:

1. An apparatus comprising:
a first wing and a second wing;
a frame support structure comprising:
an inter-wing hinge operatively coupled to the first wing and the second wing;
a center pole that bisects the inter-wing hinge; and
a pair of cross rods attached to the center pole below the first wing and the second wing;
a first folding hinge attached to a first cross rod of the pair of cross rods;
a second folding hinge attached to a second cross rod of the pair of cross rods;
a first movement transmission rod operatively coupled between a first end of the first folding hinge and an outer portion of the first wing; and
a second movement transmission rod operatively coupled between a first end of the second folding hinge and an outer portion of the second wing, wherein actuation of the first folding hinge and the second folding hinge is to move the first wing and the second wing one of up or down.

2. The apparatus of claim 1, further comprising:
a first angular lever comprising a first end operatively coupled to a second end of the first folding hinge and a second end that comprises a first hand grip; and
a second angular lever comprising a first end operatively coupled to a second end of the second folding hinge and a second end that comprises a second hand grip, wherein the second ends of the first and second angular levers are to actuate the first and second folding hinges, respectively.

3. The apparatus of claim 2, wherein centers of the first angular lever and the first folding hinge are operatively coupled together, and wherein centers of the second angular lever and the second folding hinge are operatively coupled together.

4. The apparatus of claim 2, further comprising:
a third movement transmission rod operatively coupled between the first angular lever and the first folding hinge; and
a fourth movement transmission rod operatively coupled between the second angular lever and the second folding hinge.

5. The apparatus of claim 2, wherein the frame support structure further comprises a gliding support structure attached at an end of the center pole, the gliding support structure comprising a bottom resting bar coupled between the first and second angular levers.

6. The apparatus of claim 5, wherein the gliding support structure is triangular with the bottom resting bar forming a first side, and further comprising:
a first safety bracket attached to a second side of the gliding support structure; and
a second safety bracket attached to a third side of the gliding support structure.

7. The apparatus of claim 5, further comprising a harness attached to the inter-wing hinge, the harness to hang at a position to hold a pilot within reach of the bottom resting bar.

8. The apparatus of claim 1, further comprising:
a first stop attached to a first wing support of the first wing;
a first wing opening stabilizer attached to the center pole above the first wing and having a second stop at a distal end thereof that opposes the first stop;
a third stop attached to a second wing support of the second wing; and
a second wing opening stabilizer attached to the center pole above the second wing and having a fourth stop at a distal end thereof that opposes the third stop.

9. An apparatus comprising:
a first wing and a second wing;
a frame support structure comprising:
an inter-wing hinge operatively coupled to the first wing and the second wing;
a center pole that bisects the inter-wing hinge; and
a gliding support structure comprising one or more support bars attached to the center pole and a bottom resting bar attached to the one or more support bars;
a first angular lever operatively coupled to a first end of the bottom resting bar, the first angular lever comprising a first handle bar with a first hand grip; and
a second angular lever operatively coupled to a second end of the bottom resting bar, the second angular lever comprising a second handle bar with a second hand grip.

10. The apparatus of claim 1, wherein the first wing and the second wing are bat-wing-shaped wings.

11. The apparatus of claim 9, wherein the gliding support structure is triangular with the bottom resting bar forming a first side, a first support bar forming a second side, and a third support bar forming a third side, further comprising:
a first safety bracket attached to the second side; and
a second safety bracket attached to the third side.

12. The apparatus of claim 9, further comprising a harness attached to the inter-wing hinge, the harness to hang at a position to hold a pilot within reach of the bottom resting bar.

13. The apparatus of claim 9, further comprising:
at least a first tension line coupled between the first angular lever and the inter-wing hinge; and
at least a second tension line coupled between the second angular lever and the inter-wing hinge.

14. The apparatus of claim 9, further comprising:
a first stop attached to a first wing support of the first wing;
a first wing opening stabilizer attached to the center pole above the first wing and having a second stop at a distal end thereof that opposes the first stop;
a third stop attached to a second wing support of the second wing; and
a second wing opening stabilizer attached to the center pole above the second wing and having a fourth stop at a distal end thereof that opposes the third stop.

15. The apparatus of claim 14, further comprising:
at least a first tension line coupled between the first wing opening stabilizer and a rear portion of the inter-wing hinge; and
at least a second tension line coupled between the second wing opening stabilizer and the rear portion of the inter-wing hinge.

16. The apparatus of claim 9, wherein the frame support structure further comprises a pair of cross rods attached to the center pole below the first wing and the second wing, the apparatus further comprising:
a first folding hinge attached to a first cross rod of the pair of cross rods;
a second folding hinge attached to a second cross rod of the pair of cross rods;
a first movement transmission rod operatively coupled between a first end of the first folding hinge and an outer portion of the first wing; and
a second movement transmission rod operatively coupled between a first end of the second folding hinge and an outer portion of the second wing, wherein actuation of the first folding hinge and the second folding hinge is to move the first wing and the second wing one of up or down.

17. The apparatus of claim 16, wherein centers of the first angular lever and the first folding hinge are operatively coupled together, and wherein centers of the second angular lever and the second folding hinge are operatively coupled together.

18. The apparatus of claim 16, further comprising:
a third movement transmission rod operatively coupled between the first angular lever and the first folding hinge; and
a fourth movement transmission rod operatively coupled between the second angular lever and the second folding hinge.

19. A method comprising:
attaching a frame support structure to an inter-wing hinge by inserting a center pole through the inter-wing hinge, the frame support structure further comprising a pair of cross rods attached to the center pole below the inter-wing hinge;
attaching a first wing to a first side of the inter-wing hinge, the first wing to rotate about the first side of the inter-wing hinge;
attaching a second wing to a second side of the inter-wing hinge, the second wing to rotate about the second side of the inter-wing hinge;
attaching a first folding hinge to a first cross rod of the pair of cross rods;
attaching a second folding hinge to a second cross rod of the pair of cross rods;
coupling a first movement transmission rod between a first end of the first folding hinge and an outer portion of the first wing;
coupling a second movement transmission rod between a first end of the second folding hinge and an outer portion of the second wing; and
in response to actuation of the first folding hinge and the second folding hinge, moving the first wing and the second wing one of up or down.

20. The method of claim 19, further comprising:
attaching a first end of a first angular lever to a second end of the first folding hinge, wherein a second end of the first angular lever comprises a first hand grip;
attaching a first end of a second angular lever to a second end of the second folding hinge, wherein a second end of the second angular lever comprises a second hand grip; and
actuating the first and second folding hinges in response to movement of the second ends of the first and second angular levers, respectively, via the first and second hand grips.
